(19) United States
(12) Patent Application Publication
(10) Pub. No.: US 2026/0340992 A1
(43) Pub. Date: Oct. 29, 2026

(54) Classification system for objects to be transported for a baggage transport system, such a baggage transport system, and a classification method for object to be transported

(71) Applicant: SICK AG, Waldkirch (DE)

(72) Inventors: Govinda KEMPERMANN, Gutach (DE); Jan GERBER, Sexau (DE); Josef BAAK, Waldkirch (DE); Janek BECKER, Hamburg (DE)

(21) Appl. No.: 19/654,975

(22) Filed: Apr. 22, 2026

(30) Foreign Application Priority Data
Apr. 23, 2025 (DE) 102025115634.4

(51) Int. Cl. G06V 10/764; G06V 10/12; G06V 10/80; G06V 10/94

(52) U.S. Cl. CPC G06V 10/765; G06V 10/12; G06V 10/803; G06V 10/945

(57) ABSTRACT

A classification system (1) for objects (50) to be transported for a baggage transport system (100), comprising at least one camera module (2) that is configured to capture an object (50) to be transported, wherein the at least one camera module (2) comprises a 3D image sensor (3) that is configured to generate 3D image data (5) and/or wherein the at least one camera module (2) comprises a 2D camera (4) that is configured to generate 2D image data (6). The camera module (2) is configured to transmit the 3D image data (5) and/or the 2D image data (6) to an evaluation module (15). The evaluation module (15) is configured to use an AI model (16) to determine at least one attribute (20) of the object (50). The evaluation module (15) is configured to classify the object (50) by means of a rule-based comparison (17) using the determined at least one attribute (20) and at least one rule specification (18) as to whether it is transportable on the baggage transport system (100).

The invention relates to a classification system for objects to be transported for a baggage transport system, to such a baggage transport system, and to a classification method for objects to be transported.

The inspection of objects, such as baggage and shipping items, is essential in many industrial sectors, such as logistics or airport baggage screening, to detect defective or dangerous objects. Such inspection is typically performed by appropriate personnel. For example, a specialist at an airport conveyor belt inspects the baggage passing over the conveyor belt to identify and sort out non-transportable items or special baggage.

One problem, among others, with the inspection of the conveyed objects is that the speed and reliability of the inspection depend on the person conducting it. This can lead to longer-than-necessary downtime for the baggage transport system. Additionally, defective or dangerous objects can go undetected due to human error. If such objects go undetected, damage to the baggage transport system can occur. This can result in congestion and associated follow-up costs. The baggage transport system is thus vulnerable and cannot be optimally utilized or operated at full capacity. Therefore, technical and personnel redundancies must be maintained at various points to enable a rapid response to such problems.

It can thus be regarded as an object of the invention to provide a classification system for objects to be transported for a baggage transport system, as well as such a baggage transport system and a corresponding classification method for objects to be transported.

The object is satisfied by the classification system according to claim 1, by the baggage transport system according to claim 14, and by the classification method according to claim 15. Advantageous further developments of the classification system are specified in claims 2 to 13.

The classification system according to the invention serves to classify objects to be transported, such as baggage or shipping items, for a baggage transport system. Such a baggage transport system can, for example, be used in airports. The classification system comprises at least one camera module that is configured to capture at least one object to be transported, in particular optically. The at least one camera module comprises a 3D image sensor, in particular a time-of-flight-based one. The 3D image sensor is configured to generate 3D image data of the object. In addition or alternatively, the at least one camera module comprises a 2D camera that is configured to generate 2D image data of the object. The classification system furthermore comprises an evaluation module, wherein the camera module is configured to transmit the 3D image data and/or the 2D image data to the evaluation module. The evaluation module is configured to use an AI model to determine at least one attribute of the object. The evaluation module is further configured to classify the object by means of a rule-based comparison using the determined at least one attribute and at least one rule specification as to whether it is transportable on the baggage transport system or not.

An advantage is achieved when using a camera module that comprises a 3D image sensor and/or a 2D camera. 3D image sensors provide precise depth information, which is crucial for analyzing the spatial position and the structure of an object. In a preferred combination with the high-resolution image information of a 2D camera, this enables a more accurate understanding of the shape, size, and surface texture of the object. 2D cameras provide detailed color and texture information that, together with the 3D shape information, improves the determination of the attributes of the object. This is particularly useful in complex scenarios where objects can have similar shapes but differ in color or texture, as is the case with baggage, for example. 3D image sensors, in particular those that are based on Time-of-Flight (ToF) or structured light, can function effectively regardless of illumination conditions. This complements the capabilities of 2D cameras that deliver the best results under ideal light conditions.

It is also particularly advantageous that the classification is performed in two stages. In the first stage, the at least one attribute of the object to be transported is determined. Here, the use of an AI model is particularly advantageous because the at least one attribute of the object to be transported is thereby determined in a particularly efficient manner, even for, for example, millions of different objects. In a second stage, this at least one attribute is subjected to a rule-based comparison. In this rule-based comparison, for example, it is checked whether the attribute lies within a permissible range, according to the rule specification, or not. Thanks to this novel two-stage approach, the result of the classification is comprehensible to a user. If there is an error in the classification, it is possible to verify where the error originated. The individual stages produce partial results that are interpretable by a user. The consolidation of these partial results into an “overall classification” is then performed based on an abstracted decision table, the so-called “business rules,” i.e., the rule specifications. The individual steps are designed such that they can be resolved using the available data. Furthermore, the content of these individual steps is comprehensible and verifiable to the user. As a result, feedback can be incorporated and requirements can be parameterized.

The aforementioned 3D image data are to be understood as image data which are generated by the 3D image sensor and which in particular include depth information, i.e., for example, a distance of an object represented in the image data from the 3D image sensor. In particular, the 3D information can already be calculated in the at least one camera module by means of a processing unit of the at least one camera module, e.g., by means of an ASIC (Application-Specific Integrated Circuit) provided for this purpose, such as an ISP (Image Signal Processor). The 3D information in particular enables an accurate determination of the dimensions of the object, such as a determination of the size, shape, and orientation of the object. The 3D image sensor in particular comprises a time-of-flight-based image sensor, a 3D stereo camera, and/or an SLS image sensor (Structured Light Scanning image sensor).

The 2D image data can be “conventional” image data that represent a conventional photographic two-dimensional image. The 2D image data can, for example, comprise color information, in particular high-resolution 2D RGB information, and/or grayscale information for a plurality of image pixels. The grayscale information can, for example, be generated by an IR camera, in particular under active illumination, or by converting the RGB information from an RGB camera into grayscale information. The classification of object properties can be performed using, in particular exclusively, the color information and/or using, in particular exclusively, the grayscale information. In some cases, the classification of object properties using the color information can be more advantageous, e.g., during the segmentation of the objects, while in other cases the classification of object properties using the grayscale information can be more advantageous, for example, when the background has the same color as the object or when classifying material properties of the object, wherein the grayscale information comprises, for example, an IR grayscale image that was recorded with infrared light and is displayed in grayscale.

In an advantageous further development, the at least one attribute is present in a human-readable form. This can be a text form and/or image form. As a result, it can be verified directly by a user whether the AI model has assigned the correct attribute to the object.

In an advantageous further development, the evaluation module is configured to output the at least one attribute to a user. Such an output can, for example, take place on a computer screen. It is also possible for the output to take place, for example, on a web server that is accessed by a computer of the user that displays the attribute. As a result, the user can immediately recognize which attribute has been assigned to the object.

In an advantageous further development, the evaluation module is configured to output the at least one attribute together with the result of the classification and/or the at least one rule specification to a user. Such an output can, for example, take place on a computer screen. It is also possible for the output to take place, for example, on a web server that is accessed by a computer of the user that displays the attribute. As a result, the user sees not only the attribute but also the result of the rule-based comparison or the corresponding rule specification against which the attribute was compared. The user can immediately determine whether the result of the rule-based comparison matches the determined attribute or not.

In a particular further development, the evaluation module is configured to output to a user only that at least one attribute-in particular together with the result of the classification and/or the at least one rule specification-which, according to the rule-based comparison, does not meet the rule specification. As a result, it is immediately clear to the user why the evaluation module has classified the object as non-transportable. If the object has a maximum length of, for example, 150 cm and the maximum length for an object that can be transported on the baggage transport system is 140 cm, only the attribute representing the length of the object would be output to the user.

In an advantageous further development, an input unit is provided, wherein the input unit is configured to receive a user input, and wherein the at least one attribute can be redefined in dependence on the received user input. In this case, it is possible to redefine any attributes that may have been incorrectly determined. This can also be referred to as “labeling.”

In a particular further development, the evaluation module is configured to redefine the attribute before or after the classification via the rule-based comparison in dependence on the user input.

In a particular further development, the AI model can be trained using the received user input. For example, if the AI model has assigned the attribute “suitcase” to the object and the object is actually a bag, a user can redefine the attribute through their user input, whereby the AI model is, in return, trained, in particular during operation.

In a particular further development, the evaluation module is configured to use the AI model to determine at least two, three, four, five, six, or more than six attributes of the object. As a result, the object can be characterized much more precisely.

In a particular further development, the evaluation module is configured to compare each determined attribute with a corresponding rule specification in a rule-based comparison. For example, if there are five attributes, there are also at least five rule specifications.

In an advantageous further development, the evaluation module determines a further additional attribute for the object if the at least one attribute determined so far was determined with a probability that is below a threshold value. In this case, at least one additional attribute is available in the rule-based comparison to classify whether the object is transportable on the baggage transport system or not. This addresses the issue that arises if an attribute could not be determined with certainty. In this case, further attributes are used for decision-making. If, on the other hand, an attribute is determined with a probability that is above the threshold value or above a further threshold value, the rule-based comparison can be started directly without determining an additional attribute. This saves time.

In an advantageous further development, the at least one attribute is selected from at least one of the following properties:
a) color; and/or
b) shape, such as round, angular, elongated, and/or flat; and/or
c) material, such as plastic, metal, cardboard, and/or fabric; and/or
d) dimensions, such as length, width, and/or depth; and/or
e) texture, such as soft and/or hard; and/or
f) type, such as a suitcase, bag, shipping item, and/or sports equipment; and/or
g) distinctive features, such as protruding straps, extended handles, and/or plastic wrap packaging; and/or
h) weight; and/or
i) weight distribution.

If such attributes are output, they can be verified directly by a user. The weight or weight distribution can be determined using an additional scale.

A corresponding rule specification can, for example, state that an object can have a maximum length, width, and/or depth. If the rule-based comparison reveals that the attribute representing, for example, the maximum length is greater than the maximum permissible length according to the rule specification, the object can be sorted out. Additionally or alternatively, the attribute, possibly together with the violated rule specification, can be output to a user.

In an advantageous further development, the rule specification is a specification that an attribute must meet, or a threshold value, or a range of values that an attribute must comply with. The rule specification can be customer-specific, application-specific, and/or general. A plurality of rule specifications can exist. For example, an airport can issue a general rule specification that applies to all objects. Individual airlines can also issue customer-specific rule specifications that apply only to customers of that airline. For example, Airline A can permit different dimensions than Airline B. There can also be application-specific rule specifications. For instance, a rule specification for Airline A regarding aircraft type X can differ from that for the same Airline A regarding aircraft type Y.

In a particular further development, the rule specification is present in a user-readable form. As a result, the user can directly compare the determined attribute with the rule specification.

In a particular further development, different rule specifications relate to the same attribute, with the general rule specification defining the minimum requirements the attribute must meet. This general rule specification can be restricted but not extended by the customer-specific rule specification. The customer-specific rule specification can be restricted but preferably not extended by the application-specific rule specification. This ensures that the specifications of the airport operator are always adhered to, i.e., the baggage transport system is not damaged. Restrictions arising from the airline or aircraft type merely result in more objects being classified as non-transportable than would be the case under the general rule specification. For example, if the general rule specification specifies that only objects with a maximum length of 140 cm may be transported, the customer-specific or application-specific rule specification can restrict this maximum length even further, for example to 130 cm. Although an object with a maximum length of 130 cm can be transported without any problems by the baggage transport system, it would be sorted out because, for example, there is no space for it in the corresponding aircraft. In principle, therefore, only objects that meet at least one rule specification can be transported by the baggage transport system. If, for example, the application-specific rule specification is violated, the object could in principle be transported on the baggage transport system without being damaged; however, it is still classified as non-transportable because, for example, it does not fit in the aircraft.

In a particular further development, the evaluation module is configured to use a customer-specific rule specification stored for the object and/or an application-specific rule specification stored for the object in a rule-based comparison. For example, the object can have a tag, such as a barcode, RFID chip, etc., wherein the evaluation module uses the information available via the tag to use the corresponding customer-specific rule specification and/or the corresponding application-specific rule specification.

In a particular further development, the evaluation module is configured to determine the associated airline and/or the associated aircraft type for an object in order, in dependence on the associated airline and/or the associated aircraft type, to further use a mutually corresponding customer-specific rule specification and/or a mutually corresponding application-specific rule specification for the rule-based comparison.

In an advantageous further development, at least a second, a third, or at least a fourth camera module having a 3D image sensor and/or a 2D camera is provided, wherein the at least one attribute is determined using:
a) the 3D image data and the 2D image data from only one or at least two or all camera modules; or
b) the 3D image data or the 2D image data from only one or at least two or all camera modules.

As a result, the attribute can be determined precisely because additional image data are available.

In a particular further development, the evaluation module is configured to classify an object as non-transportable if a determined attribute of this object simply does not meet one rule specification.

In a particular further development, different attributes are determined by different camera modules. Thus, the AI model is configured to determine specific attributes solely using image data from specific camera modules.

In a particular further development, at least one specific attribute is determined solely using the 3D image data of the 3D image sensor. Additionally or alternatively, at least one specific attribute is determined solely using the 2D image data of the 2D camera. When a plurality of camera modules are used, the 3D image data or the 2D image data of the plurality of camera modules can be used together to determine the specific attribute.

In an advantageous further development, at least a second, a third, or at least a fourth camera module having a 3D image sensor and/or a 2D camera is provided. The camera modules are arranged in different orientations and/or angular positions around the object to be captured so that the respective 3D image data and/or 2D image data include at least partially different regions and/or sides of the object. As a result, the object can be captured with particular precision, whereby the at least one attribute can be determined very accurately, i.e., with a high degree of probability, by the AI model.

In a particular further development, the exposure time of the 2D camera of the at least one camera module is adjusted to the speed of a conveyor belt on which the object can be transported. Thus, longer exposure times are possible when the conveyor belt is moving more slowly than when the conveyor belt is moving faster.

In a particular further development, the at least one camera module is configured to record the object when it is located on the conveyor belt and is being guided past the at least one camera module, i.e., when it is in motion. As a result, the conveyor belt does not need to be stopped.

In a particular further development, the 3D image sensor and the 2D camera have substantially the same field of view, an overlapping field of view, or mutually adjoining fields of view. The field of view refers to the region which can be captured in the image data and in which the object is contained. Preferably, for example, at least 90% of the solid angle of the field of view of the 3D image sensor and the 2D camera is identical. Preferably, the lines of sight, i.e., the orientation, of the 3D image sensor and the 2D camera are parallel.

In a particular further development, the AI model is configured to use additional image data from other camera modules if the at least one attribute to be determined is determined with a probability that is below a threshold value. As a result, the accuracy with which the determined attribute is determined can be increased.

In an advantageous further development, the evaluation module is configured to fuse together:
a) the 3D image data from a plurality of camera modules; and/or
b) the 2D image data from a plurality of camera modules; and/or
c) the 3D image data and the 2D image data from one camera module; and/or
d) the 3D image data and the 2D image data from a plurality of camera modules in particular at least partially or predominantly or completely. Based on the 3D image data and 2D image data of the respective camera modules, a multi-perspective overall image of the environment and/or the object can thus be captured and, in particular, a more precise or complete representation of reality can thus be created. During a fusion, the 2D image data can, for example, additionally be stored with depth information.

In a particular further development, the 3D image data and the 2D image data are co-registered. In particular, this is already the case during the generation of the respective image data, since the 3D image data and the 2D image data are generated in the same component, i.e., the at least one camera module. In this context, “co-registered” in particular means that the 3D image data and 2D image data are aligned spatially and temporally to enable a precise and consistent representation. In particular, no complex synchronization of the 3D image data and 2D image data is necessary, as is the case, for example, with image data from different camera modules.

In a particular further development, the evaluation module is configured to perform a temporal synchronization of the respective 2D image data and/or the respective 3D image data of the camera modules. The evaluation module can thus be configured as a central control and evaluation unit. In particular, the recordings of the individual camera modules, i.e., the 2D and/or 3D image data at a respective point in time, that are used for classifying the object can be temporally synchronized with one another, in particular can have the same timestamp.

In a particular further development, the at least one camera module is arranged in a stationary manner during operation.

In a particular further development, the at least one camera module is free of a display, in particular free of a touch-sensitive display.

In a particular further development, the at least one camera module is configured during operation such that it captures the object even without an interaction of a user.

In a particular further development, the at least one camera module is configured to transition from an operational state, in which it captures the object, to a standby state, in which it does not generate 3D image data and/or 2D image data and transmit said data to the evaluation module. The energy consumption is thereby reduced.

In a particular further development, the camera module is configured to recognize a movement, in particular of an object on a conveyor belt, and to transition from the standby state to the operational state in the event of such a recognized movement.

In a particular further development, the recognition of the movement is performed solely by the 3D image sensor or the 2D camera. Optionally, this can take place at a reduced sampling rate and/or a reduced resolution.

In a particular further development, the at least one camera module further comprises an illumination source so that in particular the 2D camera delivers optimal results. In particular, the illumination source is configured to generate light at a wavelength or within a wavelength range and to emit it onto the object, which light can be received and processed by the 2D camera. If the 2D camera operates in the IR range, the illumination source also generates light in the IR range.

In a particular further development, the 2D image data and the 3D image data comprise images that were recorded successively in time. In this case, the 2D image data and the 3D image data comprise a temporal sequence of images. By using such a temporal sequence of images, the AI model can determine the at least one attribute more accurately, i.e., with a higher probability.

In a particular further development, the 3D image sensor and the 2D camera are combined into a single component, the camera module. In this case, the camera module has a very compact design. In many cases, such as when installing a corresponding camera in a baggage screening tunnel, installation space is a critical factor. The integration of the camera module can thus be considerably simplified, in particular in hard-to-reach areas. Furthermore, the alignment of the 3D image sensor and the 2D camera relative to each other can be verified during the manufacturing of the camera module. A complex installation and calibration at the point of use is thereby eliminated.

In a particular further development, the classification system exclusively comprises one camera module. The necessary installation space for the installation of the classification system can thereby be kept to a minimum. In principle, the 3D image sensor and the 2D camera can also be accommodated in separate housings.

In a particular further development, the 2D camera is a color camera. Additionally or alternatively, the 3D image sensor is a 3D depth sensor. The accuracy for determining at least one attribute for the object is thereby increased.

In a particular further development, the 2D camera and/or the 3D image sensor has/have a high frame rate, a large opening angle, and/or a high resolution.

In a particular further development, the evaluation module comprises the AI model. Alternatively, the AI model is centrally arranged so that, for example, different evaluation modules can use the same AI model.

In a particular further development, the 2D camera comprises a processing unit that is configured to dynamically, in particular automatically, adjust image recording parameters of the 2D camera. The processing unit is, for example, an intelligent chip, such as an ISP. In other words, the 2D camera has automatic adjustment functions such as auto gain, auto white balance, auto exposure, and the like. The automatic adjustment can take place, in particular, within limits predefined for the respective application. For example, a maximum duration for the exposure time can be predefined to prevent or at least reduce motion blur.

In a particular further development, the at least one camera module and the evaluation module are connected to each other via a cable connection (e.g., electrical or optical). In principle, a wireless connection could also be used.

In a particular further development, the cable connection is configured as a coaxial cable. Via this coaxial cable, the energy supply of the at least one camera module can optionally also take place.

In a particular further development, the at least one camera module and the evaluation module are connected to each other via only one connection cable. In this case, therefore, only a single connection cable is required for the electrical connection (i.e., for the data connection and the energy supply) of the at least one camera module to the evaluation module, which significantly simplifies the connection of the at least one camera module to the evaluation module. The connection of the at least one camera module can thereby be considerably simplified, in particular in hard-to-reach areas.

In a particular further development, the 3D image sensor comprises an integrated processing device, e.g., a DSP, that calculates the depth information from 3D raw data (measured phase information of the emitted and subsequently backscattered light). The 3D raw data can (initially) be the 3D image data. The processing device can furthermore filter out invalid pixel information based on configurable criteria, perform preprocessing steps (prior to conversion into depth information) and postprocessing steps that can be parameterized in particular by the evaluation module. The processing device can add status information about the pixel data (e.g., metadata, confidence data) to the 3D image data.

In a particular further development, the 3D image sensor is a TOF sensor (Time of Flight Sensor) or an iTOF sensor (indirect Time of Flight Sensor), in particular a laser scanner or a LIDAR (Light Detection and Ranging). The 3D image sensor can in particular have a transmission light source that emits transmission light in a monitored zone. In the monitored zone, transmission light can be incident on objects that remit, i.e. reflect back, the transmission light toward the 3D image sensor. Reflected transmission light detected by the 3D image sensor can then be used to evaluate the time of flight (directly or indirectly) in order to determine the distance from the object. The transmission light can in doing so be emitted into different regions of the monitored zone in order thus to generate a depth image of the monitored zone with a large number of pixels.

In a particular further development, the 2D camera is a monochrome camera or a color camera and preferably has a resolution of at least 4 megapixels, 8 megapixels, or 12 megapixels. The 2D camera can in particular have an optics with an image sensor located behind it. An image of the monitored zone is projected onto the image sensor by the optics. The image sensor can have the aforementioned resolution of at least 4 megapixels, 8 megapixels, or 12 megapixels and can, for example, be configured as a CCD or CMOS sensor.

The classification system is thus adaptable and/or expandable depending on the application and requirements so that a flexible use is possible. Due to the combination of, in particular high-resolution, multi-view 2D and 3D image data, a high degree of classification accuracy can be achieved, as various perspectives can be captured in detail. This enables a reliable detection and/or classification of the objects, as even small objects or anomalies can be precisely recognized. In particular, the evaluation module can reduce the collected image data—i.e., the 2D and/or 3D image data—of the camera modules to essential information for further processing, in particular for classifying the object.

In a particular further development, the AI model can be trained or can have been trained based on 3D sample image data and/or 2D sample image data. The sample image data include, for example, image data which are captured by a respective camera module in 2D and/or 3D and on which one or more objects are depicted, wherein a respective object for a respective attribute is shown. The attributes that the objects possess can in particular be predefined; therefore, the data can in particular be labeled data. Additionally or alternatively, the sample image data can also comprise data that are fused by the camera modules and are used to train the AI model. The AI model can further be trained with image data that are based on different illumination conditions, in particular illuminance levels, exposure times, and/or different ambient light so that the AI model reacts less sensitively to light conditions. This makes the system particularly robust.

The AI model can, for example, be an artificial neural network, in particular a convolutional neural network (CNN). The AI model can, for example, be executed by the evaluation module or by an external computing device connected to the evaluation module and can perform the determination of the attributes of the object. Preferably, the attributes can specify properties such as various sizes, various types and/or shapes, and various values and/or states of the object. Additionally or alternatively, the object can be classified by the AI model into, in particular only, two classes, wherein one class indicates a state that is “okay” or “transportable,” and the other class indicates a state that is “not okay” or “not transportable.”

Furthermore, the hardware and software can be adapted to and optimized for the use of AI models; in particular, the hardware can be configured to process large amounts of raw data. For example, the hardware can be configured to process large amounts of raw data of the camera modules, in particular at a processing speed of up to 40 Gbit/s. To this end, the hardware can, for example, comprise GPU accelerator chips or computing devices optimized for AI applications. A classification of an object in real time can hereby be made possible, wherein the classification of an object in particular takes less than 1 second, less than 0.5 seconds, and preferably less than 0.1 seconds.

In a particular further development, the AI model is configured to perform the rule-based comparison.

In a particular further development, the AI model comprises an input layer, optionally one or more intermediate layers, and an output layer. The input layer has a plurality of nodes, wherein the 3D image data and the 2D image data of the at least one camera module can be fed to these nodes. The output layer comprises at least one node, wherein the attribute for the object can be output at this at least one node.

In a particular further development, the AI model comprises at least a first and a second neural network, wherein the first neural network is configured and used to determine a first attribute for the object, and wherein the second neural network is configured and used to determine a second attribute for the object. In this respect, the first neural network is in particular a different neural network from the second neural network. Preferably, the first neural network and the second neural network were trained with completely different or predominantly different data.

In a particular further development, the evaluation module is configured to execute the first and second neural network parallel to one another in the AI model.

In a particular further development, the AI model comprises a separate neural network for most or all the attributes.

In an advantageous further development, the rule-based comparison comprises a plurality of attributes, each having at least one rule specification. The rule-based comparison also forms a hierarchy among the plurality of attributes, wherein the object is considered transportable even if an attribute, together with its rule specification, classifies the object as non-transportable if this attribute is positioned in the hierarchy behind another attribute, together with its rule specification, that classifies the object as transportable. For example, if a first attribute is a length of 220 cm for the object and the corresponding rule specification specifies that only objects with a length of less than 150 cm are transportable, and if, for example, the second attribute, which specifies the type of object, is a surfboard and the corresponding rule specification specifies that surfboards are transportable, the object would be classified as transportable by the rule-based comparison if the second attribute is positioned before, i.e., above, the first attribute in the hierarchy.

In a particular further development, the evaluation module is configured to use the hierarchy.

In a particular further development, an input unit is provided and configured to receive a user input, wherein the evaluation module is configured to define and/or modify the hierarchy in dependence on the received user input.

In an advantageous further development, the evaluation module is configured to, in the rule-based comparison, combine a first comparison result from a first attribute with its at least one rule specification and at least a second comparison result from a second attribute with its at least one rule specification via at least one logical operator in order to classify the object based on the result of the logical operator as to whether it is transportable on the baggage transport system or not. As a result, more complex rules can be created that specify whether an object is transportable on the baggage transport system or not. For example, it can be expressed via “(Object type=Ski) AND (Length>150 cm)” that an object that is longer than 150 cm is classified as transportable only if the object is a ski. Other objects that are longer than 150 cm are then classified as non-transportable.

In a particular further development, the logical operator refers to a logical operation, in particular an AND, OR, NOT, XOR, NAND, or XNOR operation.

In a particular further development, an input unit is provided and configured to receive a user input, wherein the evaluation module is configured to derive the logical operation from the user input.

In a particular further development, an input unit is provided and configured to receive a user input, wherein the evaluation module is configured to select the first attribute and, optionally, the corresponding at least one rule specification for the first attribute based on the user input. Additionally or alternatively, the evaluation module is configured to select the second attribute and, optionally, the corresponding at least one rule specification for the second attribute based on the user input.

In a particular further development, the camera module comprises at least two 3D image sensors that are arranged spaced apart from one another and are configured to generate 3D image data of the object from different angular positions. Additionally or alternatively, the camera module comprises at least two 2D cameras that are arranged spaced apart from one another and are configured to generate 2D image data of the object from different angular positions or perspectives. As a result, the accuracy with which attributes of the object can be determined is increased. Furthermore, an attribute of the object can still be determined even if one of the at least two 3D image sensors fails and/or if one of the at least two 2D cameras fails.

In a particular further development, the 3D image data of the at least two 3D image sensors are fed to the same neural network of the AI model or to different neural networks of the AI model. Additionally or alternatively, the 2D image data of the at least two 2D cameras are fed to the same neural network of the AI model or to different neural networks of the AI model.

In a particular further development, the AI model is configured to determine all the attributes using all the 3D image data and/or all the 2D image data. Additionally or alternatively, the AI model is configured to determine at least one attribute, but not all the attributes, using the 3D image data but not the 2D image data. Additionally or alternatively, the AI model is configured to determine at least one attribute, but not all the attributes, using the 2D image data but not the 3D image data.

In a particular further development, the AI model comprises at least two neural networks, wherein the at least two neural networks are configured to determine the same attribute, wherein the object is assigned that attribute from that neural network which has the highest confidence value. A confidence value in a neural network is a numerical value that indicates the probability or certainty with which the neural network makes a specific prediction. It is typically expressed between 0 and 1 (or 0% to 100%), wherein a value close to 1 indicates a high certainty and a value close to 0 indicates a low certainty. If the attribute is the “type” of the object, the first neural network assigns the value “suitcase” to the attribute with a confidence value of 90% and the second neural network assigns the value “bag” to the attribute with a confidence value of 50%, the value “suitcase” is assigned to the attribute.

The classification system can be configured such that the camera module comprises only a 3D image sensor or a 2D camera. In this case, only 3D image data or 2D image data are generated and transmitted to the evaluation module. The evaluation module is furthermore configured to use the AI model to determine the at least one attribute of the object. The evaluation module is additionally configured to classify the object by means of the rule-based comparison using the determined at least one attribute and the at least one rule specification as to whether said object is transportable on the baggage transport system.

The baggage transport system according to the invention comprises a classification system described in the introduction. The baggage transport system is configured to sort out objects to be conveyed, in particular baggage or shipping items, if they have been classified by the classification system as not transportable by the baggage transport system. The baggage transport system in particular comprises a conveyor device, such as a conveyor belt. By sorting out these objects, it is ensured that no damage occurs to the baggage transport system or to the respective object.

The classification method according to the invention serves to classify objects to be transported for a baggage transport system. In a first method step, a capturing of an object to be transported takes place using at least one camera module that comprises a 3D image sensor and/or a 2D camera. Furthermore, 3D image data and/or 2D image data are generated. In a second method step, a transmission of the 3D image data and/or the 2D image data to the evaluation module takes place. In a third method step, a determination of at least one attribute for the captured object takes place based on the 3D image data and/or the 2D image data using an AI model by means of the evaluation module. In a fourth method step, a classification of the at least one object as to whether it is transportable on the baggage transport system takes place based on a rule-based comparison using the determined at least one attribute and at least one rule specification by means of the evaluation module.

The invention is described below purely by way of example with reference to the drawings. There are shown:

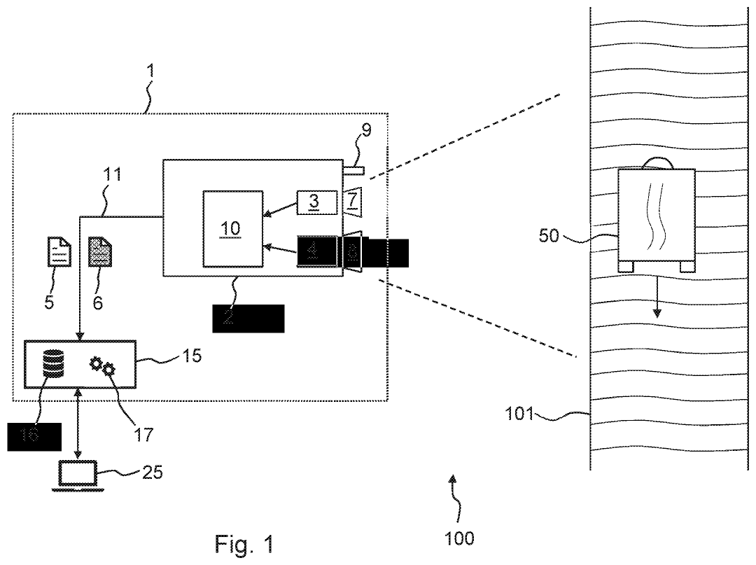

FIG. 1: an embodiment of a baggage transport system according to the invention with a classification system according to the invention;

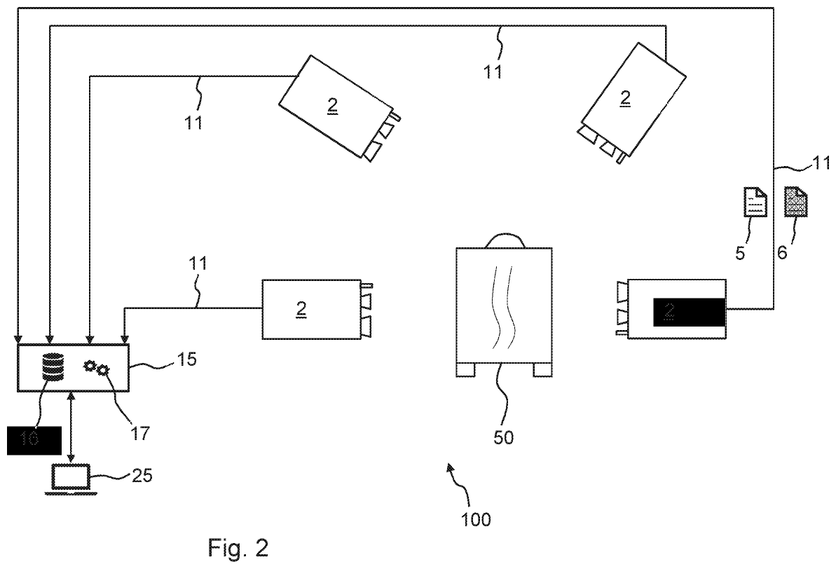

FIG. 2: a further embodiment of a baggage transport system according to the invention with a classification system according to the invention, wherein the classification system comprises a plurality of camera modules;

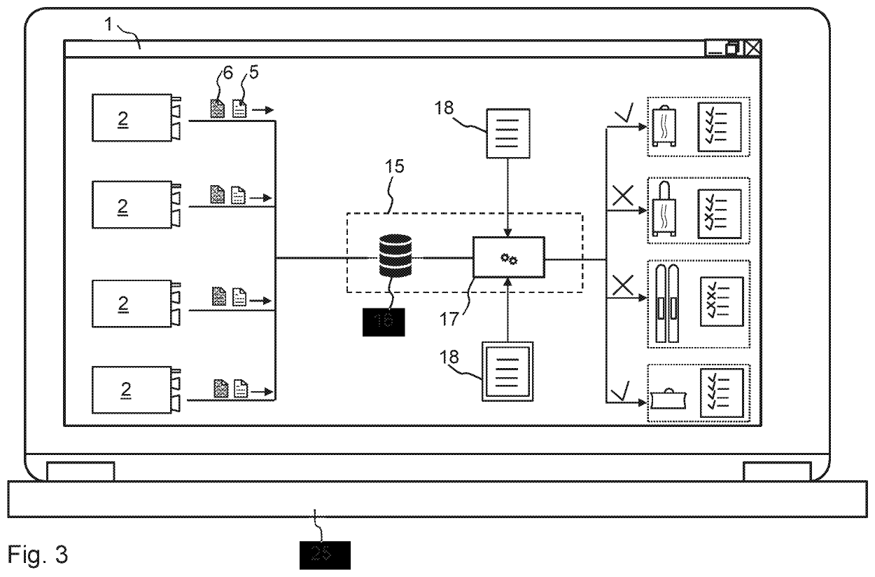

FIG. 3: an embodiment that describes the mode of operation of the classification system in more detail;

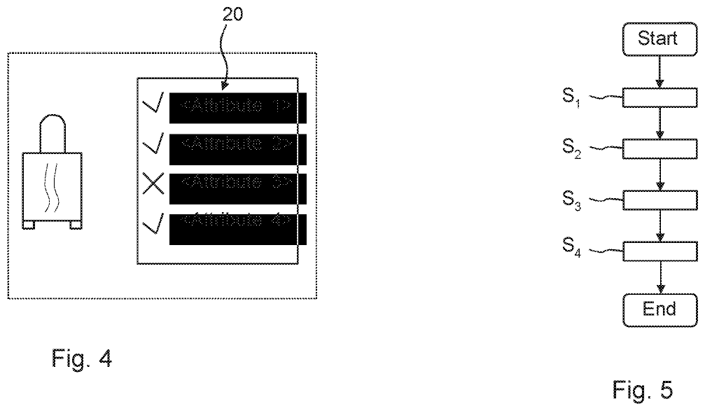

FIG. 4: an embodiment that explains a result of a classification of an object; and

FIG. 5: a flowchart that explains a classification method for objects to be transported for a baggage transport system.

FIG. 1 shows a baggage transport system 100 that comprises a classification system 1 for objects 50 to be transported. The baggage transport system 100 furthermore comprises a conveyor belt 101 on which the object 50 can be transported.

The classification system 1 has at least one camera module 2 that is configured to visually capture the object 50 to be transported. The camera module 2 comprises a 3D image sensor 3 and a 2D camera 4. The 3D image sensor 3 is configured to generate 3D image data 5. The 2D camera 4 is configured to generate 2D image data 6. The camera module 2 furthermore comprises a first lens 7 for the 3D image sensor 3 and a second lens 8 for the 2D camera 4. The camera module 2 additionally comprises an illumination source 9 that emits light onto the object 50.

The camera module 2 furthermore comprises a communication device 10 that is configured to transmit the 3D image data 5 and the 2D image data 6 via a connection 11 to an evaluation module 15 of the classification system 1. Preferably, exactly one connection cable is used as the connection 11.

The evaluation module 15 is configured to use an AI model 16 to determine at least one attribute 20 of the object 50.

The evaluation module 15 is further configured to classify the object 50 by means of a rule-based comparison 17 using the determined at least one attribute 20 and at least one rule specification 18 as to whether it is transportable on the baggage transport system 100 or not.

The result of this classification can be displayed to a user on a computer system 25.

FIG. 2 shows a further embodiment of the baggage transport system 100. In this case, the classification system 1 comprises a plurality of camera modules 2 that are arranged in different orientations and/or angular positions around the object 50 to be captured so that the respective 3D image data 5 and 2D image data 6 comprise at least partially different regions and/or sides of the object 50.

The evaluation module 15 is configured to use these additional 3D image data 5 and 2D image data 6 for the determination of at least one or more attributes 20 by means of the AI model 16.

The individual camera modules 2 are each connected to the evaluation module 15 via a connection 11. This connection 11 is a parallel connection 11. In principle, the individual camera modules 2 could also be connected to the evaluation module 15 via a serial connection, in particular a daisy-chain connection.

FIG. 3 shows an embodiment that describes the mode of operation of the classification system 1 in more detail. The classification system 1 comprises a plurality of camera modules 2 that record 3D image data 5 and 2D image data 6 of the object 50 and transmit these 3D image data 5 and 2D image data 6 to the evaluation module 15.

The evaluation module 15 is configured to use an AI model 16, which is preferably part of the classification system 1, to determine at least one attribute 20 of the object 50 using said AI model. Subsequently, a rule-based comparison 17 takes place using the determined at least one attribute 20 and at least one rule specification 18 to classify the object 50 as to whether it is transportable on the baggage transport system 100 or not.

It is also shown that the result of the classification is output in a form that is readable, i.e., interpretable, by the user. In this case, a “checkmark” or an “X” is used to indicate whether an object 50 is transportable or not. As an example, four objects 50 are shown on the right side of FIG. 3. The first object 50, shown in the upper right, is transportable. The rule-based comparison 17 has revealed that all four determined attributes 20 satisfy the rule specification 18. Consequently, all the attributes are provided with a checkmark. The second object 50, which is displayed below the first object 50, is not transportable. The rule-based comparison 17 has revealed that one determined attribute 20 does not meet the rule specification 18. This attribute is provided with an X. The third object 50, which is displayed below the second object 50, is not transportable. The rule-based comparison 17 has revealed that one determined attribute 20 does not meet the rule specification 18. This attribute is provided with an X. The fourth object 50, which is displayed below the third object 50, is transportable. The rule-based comparison 17 has revealed that all four determined attributes 20 meet the rule specification 18. In this case, both the determined attributes 20 and the information regarding which of these determined attributes 20 meet or do not meet the rule specification 18 are presented in a form that is readable, i.e., interpretable, by a user. In principle, the corresponding rule specification 18 could also be displayed next to the determined attribute 20 in a form that is readable, i.e., interpretable, by the user.

FIG. 4 shows an embodiment that explains in more detail a result of the classification of the object 50, as already shown in FIG. 3. The evaluation module 15 is configured to determine four attributes 20 of the object 50. In a rule-based comparison 17, each of these attributes 20 is compared with at least one rule specification 18. The first, second, and fourth attribute 20 meet the respective rule specification 18. This result is displayed with an indicator, for example in the form of a checkmark, next to the attribute 20. The third attribute 20 does not meet the corresponding rule specification 18. Therefore, a different indicator, in this case in the form of an X, is displayed next to the attribute 20. The user immediately recognizes which attribute 20 does not meet the corresponding rule specification 18. In this case, it is a pulled-out handle piece of the object 50 to be transported in the form of a suitcase.

FIG. 5 shows a flowchart that explains a classification method for objects 50 to be transported for a baggage transport system 100. In a first method step S₁, a capturing of an object 50 to be transported takes place using at least one camera module 2 that comprises a 3D image sensor 3 and a 2D camera 4. Furthermore, 3D image data 5 and 2D image data 6 are generated. In a second method step S₂, a transmission of the 3D image data 5 and the 2D image data 6 to the evaluation module 15 takes place. In a third method step S₃, a determination of at least one attribute 20 for the captured object 50 takes place based on the 3D image data 5 and the 2D image data 6 using an AI model 16 by means of the evaluation module 15. In a fourth method step S₄, a classification of the at least one object 50 as to whether it is transportable on the baggage transport system 100 takes place based on a rule-based comparison 17 using the determined at least one attribute 20 and at least one rule specification 18 by means of the evaluation module 15.

The invention is not limited to the described embodiments. Within the scope of the invention, all the described and/or illustrated features can be combined with one another in any desired manner.

### List of Reference Signs

classification system 1
camera module 2
3D image sensor 3
2D camera 4
3D image data 5
2D image data 6
first lens 7
second lens 8
illumination source 9
communication device 10
connection 11
evaluation module 15
AI model 16
rule-based comparison 17
rule specification 18
attribute 20
computer system 25
object 50
external event 51
baggage transport system 100
conveyor belt 101
higher-ranking control device 102
method steps S₁, S₂, S₃, S₄

1. A classification system for objects to be transported for a baggage transport system, comprising
at least one camera module that is configured to capture an object to be transported, wherein the at least one camera module:
a) comprises a 3D image sensor that is configured to generate 3D image data; and/or
b) comprises a 2D camera that is configured to generate 2D image data; and
an evaluation module, wherein the camera module is configured to transmit the 3D image data and/or the 2D image data to the evaluation module,
wherein the evaluation module is configured to use an AI model to determine at least one attribute of the object,
wherein the evaluation module is further configured to classify the object by means of a rule-based comparison using the determined at least one attribute and at least one rule specification as to whether it is transportable on the baggage transport system.

2. The classification system according to claim 1,
wherein the at least one attribute is present in a human-readable form.

3. The classification system according to claim 1,
wherein the evaluation module is configured to output the at least one attribute to a user.

4. The classification system according to claim 1,
wherein the evaluation module is configured to output the at least one attribute together with the result of the classification and/or the at least one rule specification to a user.

5. The classification system according to claim 1,
wherein an input unit is provided, wherein the input unit is configured to receive a user input, and wherein the at least one attribute can be redefined in dependence on the received user input.

6. The classification system according to claim 1,
wherein the evaluation module determines a further additional attribute for the object if the at least one attribute determined so far was determined with a probability that is below a threshold value.

7. The classification system according to claim 1,
wherein the at least one attribute is selected from:
a) color; and/or
b) shape; and/or
c) material; and/or
d) dimensions; and/or
e) texture; and/or
f) type; and/or
g) distinctive features; and/or
h) weight; and/or
i) weight distribution.

8. The classification system according to claim 1,
wherein the rule specification is a specification that an attribute must meet, or a threshold value, or a range of values that an attribute must comply with.

9. The classification system according to claim 1,
wherein the rule-based comparison comprises a plurality of attributes, each having at least one rule specification, and forms a hierarchy among the plurality of attributes, wherein the object is considered transportable even if an attribute, together with its rule specification, classifies the object as non-transportable, if this attribute is positioned in the hierarchy behind another attribute, together with its rule specification, that classifies the object as transportable.

10. The classification system according to claim 1,
wherein the evaluation module is configured to, in the rule-based comparison, combine a first comparison result from a first attribute with its at least one rule specification and at least a second comparison result from a second attribute with its at least one rule specification via at least one logical operator in order to classify the object based on the result of the logical operator as to whether it is transportable on the baggage transport system or not.

11. The classification system according to claim 1,
wherein at least a second, a third, or at least a fourth camera module having a 3D image sensor and/or a 2D camera is provided, wherein the at least one attribute is determined using the:
a) 3D image data and the 2D image data from only one or at least two or all camera modules; or
b) 3D image data or the 2D image data from only one or at least two or all camera modules.

12. The classification system according to claim 11,
wherein the camera modules are arranged in different orientations and/or angular positions around the object to be captured so that the respective 3D image data and/or 2D image data include at least partially different regions and/or sides of the object.

13. The classification system according to claim 11,
wherein the evaluation module is configured to fuse together:
a) the 3D image data from a plurality of camera modules; and/or
b) the 2D image data from a plurality of camera modules; and/or
c) the 3D image data and the 2D image data from one camera module; and/or
d) the 3D image data and the 2D image data from a plurality of camera modules.

14. A baggage transport system comprising a classification system according to claim 1,
wherein the baggage transport system is configured to sort out objects to be conveyed if they have been classified by the classification system as not transportable by the baggage transport system.

15. A classification method for objects to be transported for a baggage transport system, comprising the following method steps:
capturing an object to be transported using at least one camera module, which comprises a 3D image sensor and/or a 2D camera, and generating 3D image data and/or 2D image data;
transmitting the 3D image data and/or the 2D image data to the evaluation module;
determining at least one attribute for the captured object based on the 3D image data and/or the 2D image data using an AI model by means of the evaluation module;
classifying the at least one object as to whether it is transportable on the baggage transport system based on a rule-based comparison using the determined at least one attribute and at least one rule specification by means of the evaluation module.
